(19) United States
(12) Patent Application Publication
(10) Pub. No.: US 2008/0179511 A1
(43) Pub. Date: Jul. 31, 2008

(54) MICROSPRAY LIQUID-LIQUID EXTRACTIVE IONIZATION DEVICE

(76) Inventors: Huanwen Chen, Zurich (CH); Hao Chen, West Lafayette, IN (US); Andre Venter, West Lafayette, IN (US); R. Graham Cooks, West Lafayette, IN (US)

Correspondence Address: BRINKS HOFER GILSON & LIONE, P.O. BOX 10395, CHICAGO, IL, 60610, US

(21) Appl. No.: 11/751,718

(22) Filed: May 22, 2007

Related U.S. Application Data
(60) Provisional application No. 60/887,496, filed on Jan. 31, 2007.

(51) Int. Cl. H01J 49/10

(52) U.S. Cl. 250/282; 250/288

(57) ABSTRACT

A device enables direct, continual analysis by mass spectrometry of one or more analytes in a complex liquid sample. A first sprayer nebulizes the liquid sample, forming sample droplets. A second sprayer provides multiple charged droplets of a liquid solvent or solution. The first sprayer forms a first angle (β) relative to the second sprayer such that the analytes are transferred to the charged droplets and are desolvated to generate free gas phase ions in an interface of a mass spectrometer (MS).

### RELATED APPLICATIONS

This application claims the benefit under 35 U.S.C. § 119(e) of U.S. Provisional Patent Application No. 60/887,496, filed Jan. 31, 2007, entitled “Microspray Liquid-Liquid Extractive Ionization Device,” which is incorporated herein by reference.

### TECHNICAL FIELD

The present disclosure relates to a device that enables direct analysis of trace compounds and analytes in complex biological environmental samples by mass spectrometry without any sample preparation.

### BACKGROUND

Mass spectrometry, or mass spectroscopy, is an analytical technique used to measure the mass-to-charge ratio of ions. It is most generally used to find the composition of a physical sample by generating a mass spectrum representing the masses of sample components, or analytes. The technique has several applications, including: (1) identifying unknown compounds by the mass of the compound molecules or their fragments; (2) determining the isotopic composition of elements in a compound; (3) determining the structure of a compound by observing its fragmentation; (4) quantifying the amount of a compound in a sample using carefully designed methods (mass spectrometry is not inherently quantitative); (5) studying the fundamentals of gas phase ion chemistry (the chemistry of ions and neutrals in vacuum); and (6) determining other physical, chemical or even biological properties of compounds with a variety of other approaches.

A mass spectrometer (MS) is a device that measures the mass-to-charge (m/z) ratio of ions. This is achieved by ionizing the sample and separating ions of differing masses and recording their relative abundance by measuring intensities of ion flux. A typical MS comprises three parts: an ion source, a mass analyzer, and a detector system.

Detection of analytes as diverse as pesticides and explosives in complex matrices is of increasing importance in analytical chemistry, driven by threats to the living environment and to civil society. F. Hernandez, J. V. Sancho and O. Pozo, J. Anal. Bioanal. Chem., 2005, 382, 934-946. These applications demand rapid, sensitive and selective analytical techniques. Reducing or removing sample preparation steps prior to analysis is central to moving the analysis of complex samples out of the lab and towards automated, in situ protocols. Some of the most promising techniques for direct, real time analysis are based on new mass spectrometry methods in which samples are ionized in the ambient environment. Additional specificity is then possible from tandem mass spectrometry, high resolution, or ion mobility measurements. R. G. Ewing, D. A. Atkinson, G. A. Eiceman and G. J. Ewing, Talanta, 2001, 54, 515-529. Ambient ionization methods are already emerging on fieldable instruments. B. C. Laughlin, C. C. Mulligan and R. G. Cooks, Anal. Chem., 2005, 77, 2928-2939.

A recently developed MS ionization technique, desorption electrospray ionization (DESI), allows the examination of compounds directly from ambient surfaces, eliminating solvent extraction or other sample preparation steps prior to analysis. Z. Takáts, J. M. Wiseman and R. G. Cooks, J. Mass Spectrom, 2005, 40, 1261-1275. DESI is one of a family of ambient ionization methods which share the advantage that ion production occurs in air where the sample is fully accessible during analysis.

Components of urine and other complex matrices can be analyzed successfully by DESI as dried spots on paper or other surfaces. H. W. Chen, N. N. Talaty, Z. Takáts and R. G. Cooks, Anal. Chem., 2005, 77, 6915-6927; Takáts et al., Method and System for Desorption Electrospray Ionization, WO 2005/094389. This approach allows whole urine to be examined, eliminating clean-up steps, e.g. the removal of salts that restrict the application of other ionization methods to this important sample type. While examination of dried spots on paper is a feasible approach to high throughput analysis of fluids, it may not be useful for fragile compounds or in circumstances in which real time measurements are required. Electrospraying samples such as urine, serum, polluted water and milk directly into the inlet of a mass spectrometer causes adduct formation, sample carry-over and build-up of nonvolatile components and quickly leads to irrecoverable loss in sensitivity. Loss of sensitivity has been addressed by directing the spray off-axis with respect to the MS inlet or sampling cone, but many samples still need to be worked-up or diluted before the mass spectrometer can be used for extended periods in the analysis of complex biological samples. Such steps are unsatisfactory to many investigators.

### SUMMARY OF THE DISCLOSURE

Various embodiments are described herein directed to devices and methods for microspray liquid-liquid extractive ionization. According to one embodiment, a device enables direct, continual analysis by mass spectrometry of one or more analytes in a complex liquid sample. The device comprises a first sprayer to nebulize the liquid sample, forming sample microdroplets. A second sprayer provides multiple charged droplets of a liquid solvent or solution. The first sprayer forms a first angle (β) relative to the second sprayer such that the analytes are transferred to the charged droplets and are desolvated to generate free gas phase ions in an interface of a mass spectrometer (MS). The sample droplets collide with the charged droplets when the analytes are transferred to the charged droplets to cause the analytes to travel along a predetermined path leading to the MS interface.

According to another embodiment, the device comprises a first sprayer to nebulize the liquid sample, forming sample microdroplets containing analytes. A second sprayer provides multiple charged droplets of a liquid solvent or solution, the first and second sprayers oriented relative to each other so that the microdroplet spray intersects the charged droplet spray and causes analytes to be transferred to the charged droplets, which are desolvated to generate free gas phase ions in an interface of a mass spectrometer (MS).

According to yet another embodiment, an ion source device of a mass spectrometer enables real time, direct analysis of a complex liquid sample. The device comprises a first sprayer having a first flow rate to nebulize a liquid sample or solution, forming sample microdroplets that contain analytes. An ionization system has a second sprayer with a second flow rate to provide multiple charged droplets of a liquid solvent. The first sprayer forms a first angle (β) relative to the second sprayer such that the analytes are transferred to the charged droplets and are desolvated to generate free gas phase ions in a MS interface. The sample droplets collide with the charged droplets when the analytes are transferred to the charged droplets to cause the analytes to travel along a predetermined path leading to the MS interface.

The first and second flow rates may be set so as to produce an increased effective production of analyte ionization. The first sprayer may be set at a second angle (α) relative to the MS inlet. The first (β) and second (α) angles may be set to produce an increased effective production of analyte ionization. The first (β) and second (α) angles may be set to enhance the long-term stability of the real time analysis.

In the above embodiments, the devices include a high voltage power supply connected to the second sprayer to facilitate production of the charged droplets of the liquid solvent or solution.

In yet another embodiment, a method of ionization of a raw, complex liquid sample of mass spectrometric analysis comprises spraying the liquid sample through a first sprayer to form nebulized sample microdroplets containing analytes. A liquid solvent or solution is sprayed through a highly charged second sprayer to form nebulized charged droplets. The first and second sprayers are aimed at a mutual first angle (β) relative to each other so that the analytes within the microdroplets are transferred to the charged droplets and desolvate to generate free gas phase ions in a MS interface.

Aiming the first and second sprayers at a mutual first angle (β) to each other creates a second angle (α) between the first sprayer and the MS interface. The method further comprises setting the first (β) and second (α) angles to produce an increased effective production of analyte ionization. The method further comprises setting the first (β) and second (α) angles to enhance the long-term stability of the continual analysis.

### BRIEF DESCRIPTION OF THE DRAWINGS

A more particular description of the disclosure briefly described above will be rendered by reference to the appended drawings. Understanding that these drawings only provide information concerning typical embodiments and are not therefore to be considered limiting of its scope, the disclosure will be described and explained with additional specificity and detail through the use of the accompanying drawings.

FIG. 1 is a cross sectional view of a device for microspray liquid-liquid extraction ionization, or extractive electrospray ionization (EESI), showing ionizing and sample spray streams colliding to feed ionized analytes to a mass analyzer (MS).

FIG. 2 displays a total ion chromatogram (TIC) graph of an enlarged 15 minute region towards the end of a 7-hour analysis, indicating long-term stability of a raw urine signal for a sample spiked with 2×10⁻⁹ mol·L⁻¹ atrazine.

FIG. 3 is a mass spectrum graph displaying the results of EESI of cow's milk, directly infused at 1 μL/min without dilution or sample preparation.

FIG. 4 is a mass spectrum graph displaying the results of EESI of undiluted urine spiked with 1×10⁻⁹M atrazine and 1×10⁻¹²M cyclonite (or RDX), after an average of four 200 ms scans, and the insert shows the MS³ analysis of atrazine using methanol water.

FIG. 5A is a mass spectrum graph displaying the results of analysis of 1×10⁻¹²M 2,4,6 Trinitrotoluene (TNT) in river water by direct analysis and the insert shows the MS² spectrum of m/z 227 of the radical anion of TNT.

FIG. 5B is a mass spectrum graph displaying the results of analysis of 1×10⁻¹²M TNT in river water by ion/molecule reactions, which yielded the diagnostic Meisenheimer complex of TNT, and the insert shows the fragmentation obtained for the Meisenheimer complex.

### DETAILED DESCRIPTION OF PREFERRED EMBODIMENTS

The embodiments of this disclosure will be best understood by reference to the drawings, wherein like parts are designated by like numerals throughout. It will be readily understood that the components of the embodiments, as generally described and illustrated in the Figures herein, could be arranged and designed in a wide variety of different configurations. Thus, the following more detailed description of various embodiments, as represented in the Figures, is not intended to limit the scope of the disclosure, as claimed, but is merely representative of various embodiments. While the various aspects of the embodiments are presented in drawings, the drawings are not necessarily drawn to scale unless specifically indicated. In addition, the steps of a method do not necessarily need to be executed in any specific order or even sequentially, unless otherwise specified.

As discussed, applications of mass spectrometry include the analysis of trace compounds in complex biological and environmental samples, which in some cases is difficult to do in real time or on a direct, continual basis because preparation of samples is required. Preparation of the samples, in part, has been required because of the presence of salts, contaminants, and other compounds in complex biological and environmental samples that would normally interfere with the mass spectrometric analysis. Other reasons were discussed previously.

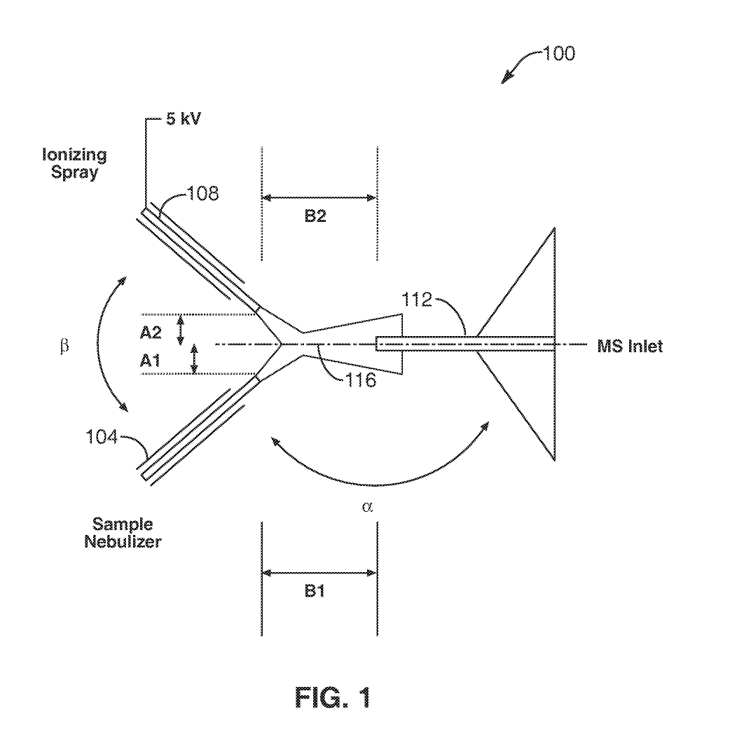

FIG. 1 is a cross sectional view of a device 100 for microspray liquid-liquid extraction ionization, which in part, has been developed to eliminate sample preparation in the direct analysis of complex biological and environmental samples by mass spectrometry. To perform what has also been termed extractive electrospray ionization (EESI), device 100 comprises two separate sprayers, including a sample sprayer 104 to nebulize a sample analyte solution, thus producing sample microdroplets, and an ionization solvent sprayer 108 to create a fine mist of charged droplets. The solvent is ionized when it exits sprayer 108, which is connected to a high voltage power supply to produce both positive and negative ions. The charged droplets interact with the sample droplets to extract and ionize the analytes present in the nebulized sample. The EESI process allows for compounds of interest to be analyzed by mass spectrometry despite the presence of salts and other compounds that would normally interfere with the mass spectrometric analysis. When this disclosure refers to compounds, it is assumed to include the term “analytes,” which are present in those compounds.

Device 100 is advantageously designed to function in the field, at the location of a compound in need of continual monitoring by mass spectrometry analysis. As a result, device 100 may be operated at atmospheric pressure, but alternatively, may also be operated under pressurized conditions, whether increased or reduced. Device 100 will also allow significant increases in sample throughput and reductions in toxic solvent usage.

Device 100 is arranged so that sprayer 104 is at an angle β with respect to sprayer 108 and also such that sprayers 104 and 108 are both at an angle α with respect to a MS inlet 112. It should be evident that as angle β is increased, angle α necessarily decreases. Generally there is a tradeoff between high sensitivity, which is favored at large values for α, and long term stability favored by values of α approaching 90°. The sprays from respective sprayers 104 and 108 should intersect to create the desired result of continual, real-time ionization.

Additionally, a distance A1 may be set between sample sprayer 104 and a midline path 116; a distance A2 may be set between ionization sprayer 108 and midline path 116; a distance B1 may be set between sprayer 104 and MS inlet 112; and a distance B2 may be set between sprayer 108 and MS inlet 112. These geometric parameters β, α, A1, A2, B1, and B2 (variably referred to as “geometric parameters”) are easily tunable so that charged droplets from the ionization sprayer 108 collide with sample droplets from the sample sprayer 104 at the proper angle so that, given a liquid flow rate of respective sprayers 104, 108, analytes of interest are directed along path 116 that leads to MS inlet 112. It is clear that these geometric parameters, along with gas pressure, and liquid flow rates, depend on each other to some extent, and so a certain amount of experimentation is needed to determine effective ionization given differing combinations. But, as mentioned, these parameters are easily tunable, and therefore only basic trial and error would be required. One non-limiting example of geometric parameters used in experiments disclosed herein include: A1 of about 1 mm; A2 of about 2 mm; B1 of about 3 mm; and B2 of about 2.5 mm.

Additionally, the accuracy needed to direct the analytes toward MS inlet 112 so that they enter therein may vary depending on the type of MS used, and therefore, tuning the geometric parameters for different MSs may produce an increased effective production of analyte ionization. This sort of tuning may be compared to the functioning of billiard balls on a billiard table, except that analytes are extracted from the sample droplets by collision with the charged droplets before making their way along path 116. Use of a cone-shaped MS inlet 112 may allow for multiple, substantially parallel paths 116 which will ultimately lead the analytes into the associated mass spectrometer.

In addition, EESI takes advantage of the natural surface selectivity of certain (analyte) molecules in certain liquid droplets and transfers these specific analytes with their unique position pre-concentrated on the surface into a receiving droplet. Such a process transfers analytes into a pure ionized solvent microdroplet, making their way to MS inlet 112 for analysis.

EESI advantageously extracts the compounds of interest from the sample analyte solution by the solvent spray in a continuous, automatic fashion with no other sample preparation steps being required, and can operate over an extended period of time without compromising the analytical performance of the MS. For stability tests, needed for quantitative analysis, the raw (unprepared) sample solutions were delivered directly from an infusion pump at flow rates between 1 and 10 μL/min. The ionizing solvent spray, delivered at 5 and 10 μL/min, was a mixture of methanol/water/acetic acid (45:45:10). Sprayers 104 and 108 both operate in a mode similar to that used in electrosonic spray ionization (ESSI) with dry nitrogen at 200 psi being used as the nebulizing gas. Sprayers 104 and 108 were positioned at an angle α to a Finnigan LTQ MS inlet 112 and at an angle β with respect to each other such that the ionized analyte molecules are directed towards the MS inlet by the combined aerodynamic effect of both sprayers 104, 108. The charged ionizing spray turbulently mixes with the nebulized sample spray.

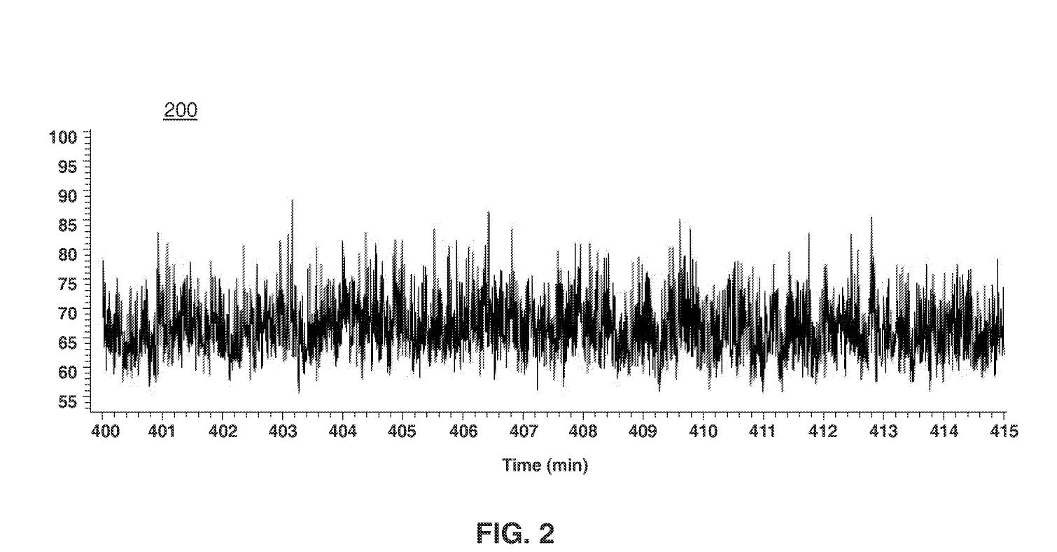

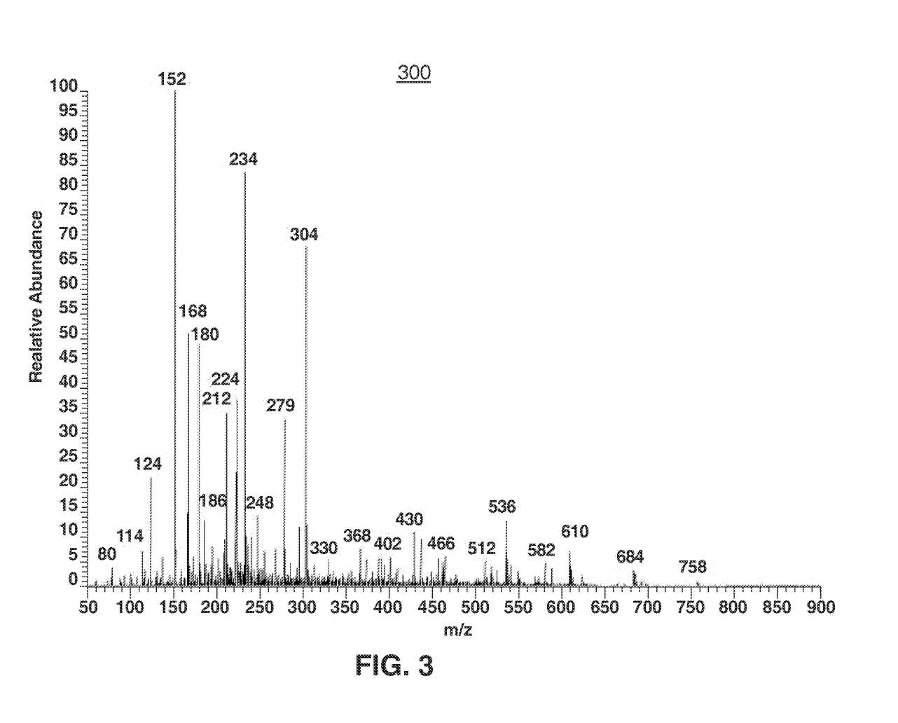

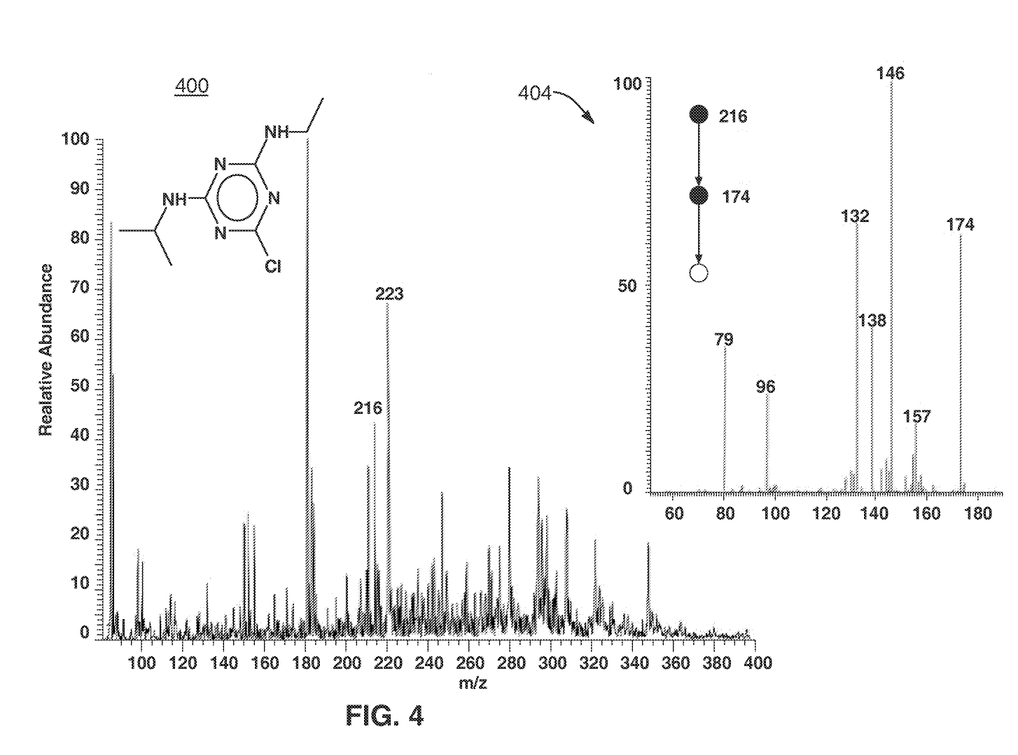

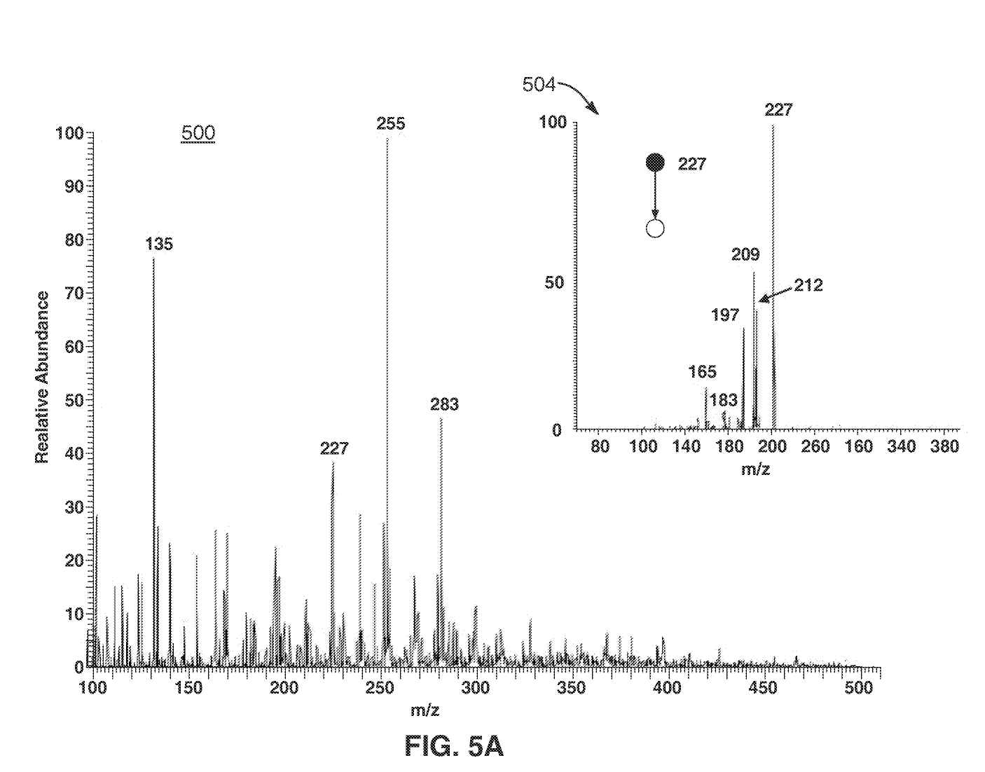

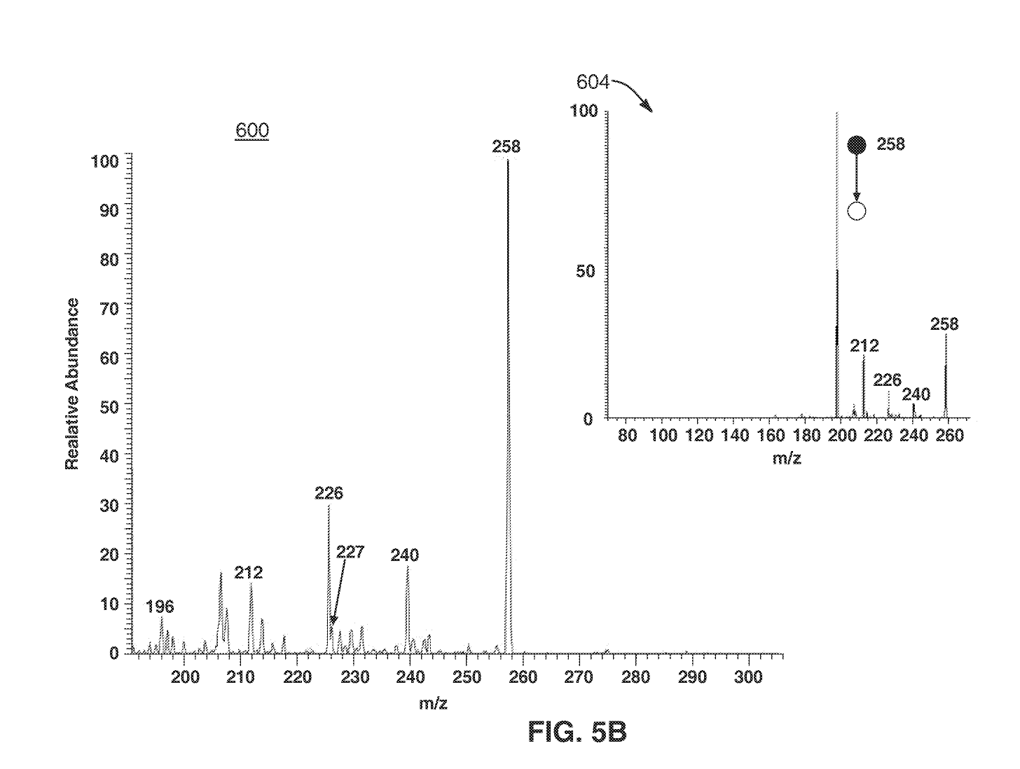

Good results were obtained for many combinations of angles α and β. Again, there is a tradeoff between high sensitivity, which is favored at large values for α, and long term stability favored by values of α approaching 90°. The urine and milk analyses data of FIGS. 2 and 3 were taken at α=β=90° whereas the low detection level data reported in FIGS. 4 and 5 were obtained with α=120° and β=60°. Solvent sprayer 108 was connected to a high voltage power supply and spray voltages of 3 to 5 kV were used in both positive and negative ion modes. The analytes are ionized without compromising the analytical performance of the mass spectrometer, even after prolonged exposure to the complex matrix.

Primary uses of the EESI device 100 include analysis of pharmacologically important metabolites in urine, serum, and other biological fluids, in addition to contaminants such as pesticides and industrial waste in sources of drinking water and other aqueous environmental samples. Device 100 can also be used to control the amounts of additives in food and beverages such as antibiotics in milk samples. Additionally, device 100 enables the analysis of organic ionizable materials in organic solvents that typically do not allow ionization by electrospray ionization, such as polar compounds in hydrocarbon fuels or additives and stabilizers in bulk organic materials. Finally, device 100 can be used in procedures to obtain an increase in signal from complex samples by using diverse chemical transformations to increase analytical response. These uses, of course, are exemplary only and may be expanded upon as applied by those of skill in the art.

FIG. 2 displays a total ion chromatogram (TIC) graph 200 of an enlarged 15 minute region towards the end of a 7-hour analysis, indicating long-term stability of a raw urine signal for a sample spiked with 2×10⁻⁹ mol·L⁻¹ atrazine. Graph 200 demonstrates the signal stability over long analysis times obtained for raw, undiluted human urine analyzed for seven consecutive hours. An enlarged section of 15 minutes towards the end of the run is shown. The sample was infused at 5 μL/min with a 250 μL glass syringe. Sharp negative spikes occurred at 70, 130, 190, 250, 320 and 390 minutes due to artifacts caused when the syringe was refilled. While the signal appears noisy as compressed here, it is stable over the few seconds required for individual sample analysis.

Individual mass spectra show numerous compounds present in raw urine necessitating the use of tandem MS analysis for identification and quantification of target analytes. The mass spectra did not change appreciatively from the beginning to the end of the 7-hour experiment. The stability and signal intensity depends on the relative positioning of sprayers 104, 108. Detections of certain compounds and analytes as referred to herein are exemplary only, as determined through experimentation, and are not meant to be limiting in any way.

FIG. 3 is a mass spectrum graph 300 displaying the results of microspray liquid-liquid extraction ionization of cow's milk, directly infused at 1 μL/min without dilution or sample preparation. The cow's milk included unfiltered river water and similar results under similar test conditions were obtained when compared with those of the experiment of FIG. 2. Apart from long term stability, the dual-spray, or EESI approach also provides heightened sensitivity, apparent with reference to FIG. 4.

FIG. 4 is a mass spectrum graph 400 displaying the results of ESSI of undiluted urine spiked with 1×10⁻⁹M atrazine and 1×10⁻¹²M cyclonite (or RDX), after an average of four 200 ms scans. An insert 404 of graph 400 shows the MS³ analysis of atrazine using methanol water. The direct monitoring of atrazine at low levels by dual spray ESSI is demonstrated. A 0.8-minute infusion of a 1×10⁻¹³M solution of atrazine in methanol/water at 1 μL/min allowed MS³ analysis to be obtained as demonstrated in insert 404. Note the expected improvement in signal-to-noise ration (S/N) in the MS³ viz-a-viz the MS data. The product ion spectrum of protonated atrazine (m/z 216) yields a main fragment at m/z 174 after loss of CH₃CH═CH₂. This is followed by the loss of neutral CH₂═CH₂ to produce the m/z 146 fragment ion. The most abundant ion at m/z 174 was isolated for the MS³ experiment. Collision-induced dissociation (CID) produced ions at m/z 157, 146, 138 and 132 by losses of NH₃, CH₂═CH₂, HCl, and CH₂═C═NH, respectively. Very low levels of RDX and atrazine were also observed by EESI in undiluted mouse urine. Many of the components typically found in mammalian urine were observed including creatine, glucose and urea.

FIG. 5A is a mass spectrum graph 500 displaying the results of analysis of 1×10⁻¹²M 2,4,6 Trinitrotoluene (TNT) in river water by direct analysis. An insert 504 of graph 500 shows that the radical ion corresponding to TNT (m/z 227) occurs in the mass spectrum MS², which was confirmed by CID. Ion/molecule reactions can be deliberately performed during the droplet collision event at atmospheric pressure. These reactions can be used to improve detection levels or to confirm the presence of analytes in dirty matrices by selective reactions.

FIG. 5B is a mass spectrum graph 600 displaying the results of analysis of 1×10⁻¹²M TNT in river water by ion/molecule reactions, which yielded the diagnostic Meisenheimer complex of TNT. An insert 604 of graph 600 shows the fragmentation obtained for the Meisenheimer complex. A solution of 1 ppm sodium methoxide in methanol was used as the ionizing spray to produce CH₃O⁻ anions. These reacted with TNT to form the Meisenheimer complex at m/z 258. The identity of the ion was confirmed by CID, which produced fragments at m/z 240, 226, 212 and 198 due to the loss of water, methanol and ⁻CH₂NO₂, respectively.

Yet another sample type that is hard to analyze directly by mass spectrometry without sample preparation is represented by powdered materials. While such samples can be extracted for regular electrospray ionization (ESI) analysis or tabletized for DESI, they can also be analyzed by EESI directly from the powder. The analysis is performed by filling the tip of a capillary with powder and dispersing the powder by forced air flow. As an example, the contents of a pharmaceutical capsule were dispersed by the sample spray and the active ingredient, acetaminophen, was observed by the mass spectrometer as the protonated molecular ion at m/z 152. This allowed direct atmospheric analysis of analytes in powder form with minimal carry over and without contaminating the inlet with the powder. Applications to aerosols can also be envisioned.

The advantage of EESI is evident by the rapid loss in signal intensity observed in conventional ESI/APCI (atmospheric pressure chemical ionization) ion sources when diluted urine is infused. H. Chen, Z. Pan, N. Talaty, S. Zhang, C. Duda, R. G. Cooks and D. Raftery, Rapid Commun. Mass Spectrom., 2006, in press. By contrast, EESI as an ion source offers good tolerance even to undiluted urine samples flowing at similar rates for very long periods. No significant loss in signal was observed after many hours of analysis of raw urine. Under optimal conditions, EESI mass spectrometry provides sensitivity approaching that of ESI-MS but with the continuous operation already noted. The inherent flexibility of the dual sprayer configuration offers the ability to perform ion/molecule reactions at atmospheric pressure to improve sensitivity and/or selectivity. These features ensure that EESI will find application in the analysis of trace compounds present in other complex matrices such as serum. Applications in metabolite profiling for differential metabolomics in biofluids and manipulation of charge in the state of biopolymers are likely to be important to the United States Army Corps of Engineers.

The terms and descriptions used herein are set forth by way of illustration only and are not meant as limitations. Those skilled in the art will recognize that many variations can be made to the details of the above-described embodiments without departing from the underlying principles of the disclosure. The scope of the disclosure should therefore be determined only by the following claims (and their equivalents) in which all terms are to be understood in their broadest reasonable sense unless otherwise indicated.

1. A device to enable direct, continual analysis by mass spectrometry of one or more analytes in a complex liquid sample, comprising:
a first sprayer to nebulize the liquid sample, forming sample microdroplets; and
a second sprayer to provide multiple charged droplets of a liquid solvent or solution, the first sprayer forming a first angle (β) relative to the second sprayer such that the analytes are transferred to the charged droplets and are desolvated to generate free gas phase ions in an interface of a mass spectrometer (MS).

2. The device of claim 1, wherein the extraction and ionization of the one or more analytes occurs at atmospheric pressure.

3. The device of claim 1, wherein the sample droplets collide with the charged droplets when the analytes are transferred to the charged droplets to cause the analytes to travel along a predetermined path.

4. The device of claim 3, wherein the predetermined path leads to an inlet of the MS.

5. The device of claim 4, wherein the first sprayer is located at a second angle (α) relative to the MS inlet.

6. The device of claim 5, wherein the first (β) and second (α) angles are set to produce an increased effective production of analyte ionization.

7. The device of claim 5, wherein the first (β) and second (α) angles are set to enhance the long-term stability of the continual analysis.

8. The device of claim 1, wherein the second sprayer is connected to a high voltage power supply.

9. The device of claim 1, wherein the liquid solvent or solution comprises a mixture of methanol, water and acetic acid.

10. A device to enable direct, continual analysis by mass spectrometry of one or more analytes in a complex liquid sample, comprising:
a first sprayer to nebulize the liquid sample, forming sample microdroplets containing analytes; and
a second sprayer to provide multiple charged droplets of a liquid solvent or solution, the first and second sprayers oriented relative to each other so that the microdroplet spray intersects the charged droplet spray and causes analytes to be transferred to the charged droplets, which are desolvated to generate free gas phase ions in an interface of a mass spectrometer (MS).

11. An ion source device of a mass spectrometer that enables real time, direct analysis of a complex liquid sample, the device comprising:
a first sprayer having a first flow rate to nebulize a liquid sample or solution, forming sample microdroplets that contain analytes; and
an ionization system having a second sprayer having a second flow rate to provide multiple charged droplets of a liquid solvent, the first sprayer forming a first angle (β) relative to the second sprayer such that the analytes are transferred to the charged droplets and are desolvated to generate free gas phase ions in an interface of a mass spectrometer (MS).

12. The device of claim 11, wherein the interface of the MS is an inlet and the first sprayer is located at a second angle (α) relative to the MS inlet.

13. The device of claim 12, wherein the first (β) and second (α) angles are set to produce an increased effective production of analyte ionization.

14. The device of claim 12, wherein the first (β) and second (α) angles are set to enhance the long-term stability of the real time analysis.

15. The device of claim 11, wherein the first and second flow rates are set to produce an increased effective production of analyte ionization.

16. The device of claim 11, wherein the first and second flow rates are set to enhance the long-term stability of the real time analysis.

17. The device of claim 11, wherein the ionization system includes a high voltage power supply connected to the second sprayer.

18. The device of claim 11, wherein the sample droplets collide with the charged droplets when the analytes are transferred to the charged droplets, which causes the analytes to travel along a defined path.

19. A method of ionization of a raw, complex liquid sample for mass spectrometric analysis, comprising:
spraying the liquid sample through a first sprayer to form nebulized sample microdroplets containing analytes;
spraying a liquid solvent or solution through a highly charged second sprayer to form nebulized charged droplets; and
aiming the first and second sprayers at a mutual first angle (β) relative to each other so that the analytes within the microdroplets are transferred to the charged droplets and desolvate to generate free gas phase ions in an interface of a mass spectrometer (MS).

20. The method of claim 19, wherein aiming the first and second sprayers at a mutual first angle (β) to each other creates a second angle (α) between the first sprayer and the MS interface, the method further comprising:
setting the first (β) and second (α) angles to produce an increased effective production of analyte ionization.

21. The method of claim 19, wherein aiming the first and second sprayers at a mutual first angle (β) to each other creates a second angle (α) between the first sprayer and the MS interface, the method further comprising:
setting the first (β) and second (α) angles to enhance the long-term stability of the continual analysis.

22. The method of claim 19, further comprising:
adjusting a first flow rate of the first sprayer to produce an increased effective production of analyte ionization.

23. The device of claim 19, further comprising:
adjusting a second flow rate of the second sprayer to produce an increased effective production of analyte ionization.
